(19) United States
(12) Patent Application Publication
(10) Pub. No.: US 2020/0175852 A1
(43) Pub. Date: Jun. 4, 2020

(54) DATA COLLECTION SYSTEM, INFORMATION PROCESSING APPARATUS, COMMUNICATION NODE, AND DATA COLLECTION METHOD

(71) Applicant: FUJITSU LIMITED, Kawasaki-shi (JP)

(72) Inventors: Koichiro YAMASHITA, Hachioji (JP); Takahisa SUZUKI, Yokohama (JP)

(73) Assignee: FUJITSU LIMITED, Kawasaki-shi (JP)

(21) Appl. No.: 16/673,315

(22) Filed: Nov. 4, 2019

(30) Foreign Application Priority Data
Nov. 30, 2018 (JP) 2018-225305

(51) Int. Cl. G08G 1/01; G08G 1/127; H04W 4/38

(52) U.S. Cl. CPC G08G 1/0116; H04W 4/38; G08G 1/127

(57) ABSTRACT

A data collection system includes an information processing apparatus, and a communication node coupled to the information processing apparatus, wherein the information processing apparatus is configured to acquire a predetermined event occurrence time from a server, calculate an activation start time that is earlier than the acquired event occurrence time by an activation period of the communication node, and transmit the calculated activation start time to the communication node, and the communication node is configured to start activation at the activation start time received, and acquire predetermined data detected by a sensor upon completion of the activation, and transmit the acquired predetermined data to the information processing apparatus.

### CROSS-REFERENCE TO RELATED APPLICATION

This application is based upon and claims the benefit of priority of the prior Japanese Patent Application No. 2018-225305, filed on Nov. 30, 2018, the entire contents of which are incorporated herein by reference.

### FIELD

The embodiments discussed herein are related to a data collection system, an information processing apparatus, a communication node, and a data collection method.

### BACKGROUND

There have been sensor systems each including: a sensor tag including a sensor that measures the state of a measurement target portion of a measurement target object and a communication unit that has a function of wirelessly transmitting measurement information of the sensor; and a reader-writer having a function of receiving the measurement information wirelessly transmitted from the communication unit.

The sensor tag is configured to be capable of switching between a first state in which the communication unit wirelessly transmits the measurement information of the sensor at a first transmission time interval and a second state in which the communication unit wirelessly transmits the measurement information of the sensor at a second transmission time interval shorter than the first transmission time interval.

In the first state, the communication unit performs carrier sensing at a first carrier sensing time interval, and in the second state, the communication unit performs carrier sensing at a second carrier sensing time interval shorter than the first carrier sensing time interval.

For example, related techniques are disclosed in Japanese Laid-open Patent Publication No. 2013-109561 and so on.

### SUMMARY

According to an aspect of the embodiments, an apparatus includes a data collection system includes an information processing apparatus, and a communication node coupled to the information processing apparatus, wherein the information processing apparatus is configured to acquire a predetermined event occurrence time from a server, calculate an activation start time that is earlier than the acquired event occurrence time by an activation period of the communication node, and transmit the calculated activation start time to the communication node, and the communication node is configured to start activation at the activation start time received, and acquire predetermined data detected by a sensor upon completion of the activation, and transmit the acquired predetermined data to the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a data collection system according to an embodiment;

FIG. 2 is a perspective view of a computer system that implements an information server;

FIG. 3 is a block diagram for explaining a configuration of main parts inside a main body of the computer system;

FIG. 4 is a diagram illustrating a configuration of the information server;

FIG. 5 is a diagram illustrating a configuration of a gateway;

FIG. 6 is a diagram illustrating a configuration of a sensor node;

FIGS. 7A to 7C are diagrams for explaining modes of the sensor node;

FIG. 8 is a diagram illustrating an example of installation locations of the gateway and the sensor node;

FIG. 9 is a diagram for explaining a measurement approach utilizing a partial sleep mode of the sensor node;

FIG. 10 is a diagram illustrating an example of schedule data;

FIG. 11 is a diagram for explaining a measurement approach utilizing a sleep mode;

FIG. 12 is a flowchart illustrating a process in which a control apparatus of the gateway initializes sensor nodes;

FIG. 13 is a flowchart illustrating a process of initializing the sensor nodes,

FIG. 14 is a flowchart illustrating processes executed by the gateway;

FIG. 15 is a flowchart illustrating processes executed by the sensor nodes;

FIG. 16 is a flowchart illustrating processes executed by the gateway; and

FIG. 17 is a flowchart illustrating processes executed by the sensor nodes.

### DESCRIPTION OF EMBODIMENTS

The above sensor system performs measurement at a first measurement time interval in the first state and performs measurement at a second measurement time interval longer than the first measurement time interval in the second state. For this reason, whether the sensor system is performing measurement at the first measurement time interval or the second measurement time interval, if an incident to be measured occurs during the measurement time interval, the sensor system fails to acquire measurement data at the time when the incident occurred and during a predetermined period immediately after the occurrence of the incident. Particularly, for example, if an incident occurs during the standby phase in the first state and the switching to the second state is thus delayed, the sensor system is unable to acquire measurement data for a longer period of time.

If the measurement by the sensor were conducted all the time, there would be no period of time during which the sensor system was unable to acquire measurement data. In this case, however, the consumed electric power increases and makes it difficult to efficiently collect data.

In view of the above, it is desirable to provide a data collection system, an information processing apparatus, a communication node, and a data collection method that are capable of efficiently collecting data.

Hereinafter, embodiments of a data collection system, an information processing apparatus, a communication node, and a data collection method of the disclosure will be described.

### Embodiment

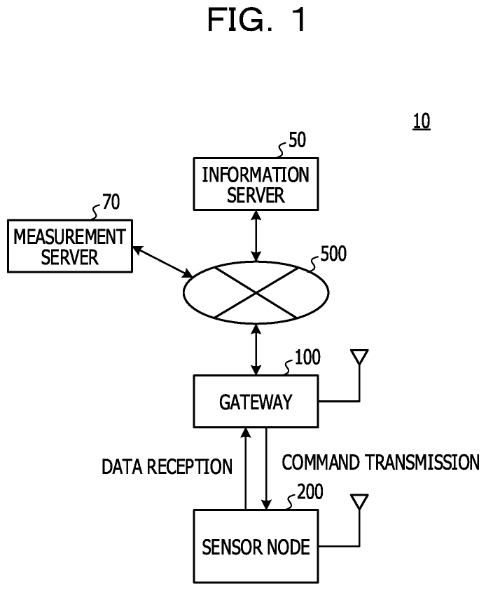

FIG. 1 is a diagram illustrating a data collection system 10 according to the embodiment. The data collection system 10 includes an information server 50, a measurement server 70, a gateway 100, and a sensor node 200. Hereinafter, although the embodiment in which the data collection system 10 includes the information server 50 and the measurement server 70 will be described, the data collection system 10 may not include the information server 50 and/or the measurement server 70.

The data collection system 10 is a system that efficiently collect data by, based on an event occurrence time which the gateway 100 has acquired from the information server 50, activating the sensor node 200 at a time earlier by an activation period than the event occurrence time, and then measuring an incident caused by the event from the beginning by means of the sensor node 200. The conditions on data collection are designated by the measurement server 70.

The event is for example an event in which a vehicle passes through a predetermined location. The predetermined location is for example a bridge as a structure alongside a road and is a measurement target for which an incident is to be measured by the sensor node 200.

The incident caused by the event is for example vibration generated by a vehicle passing through the bridge. The vehicle is a car, an electric railcar, a diesel railcar, a ship, an airplane, a carriage, or the like, and is what moves with a human, an animal, a cargo, or the like loaded thereon.

The information server 50 is coupled to the measurement server 70 and the gateway 100 via the Internet 500 to be capable of communicating data with the measurement server 70 and the gateway 100. The information server 50 is an example of a server. The information server 50 holds schedule data, road traffic data, and the like, for example, and transmits data and the like to be used for the operation of the sensor node 200 to the gateway 100. One of the data to be transmitted to the gateway 100 is data representing an event occurrence time.

When conditions on data collection are inputted by a user, the measurement server 70 notifies the information server 50 and the gateway 100 of the conditions on data collection via the Internet 500. The measurement server 70 collects data detected by the sensor node 200 via the gateway 100.

The gateway 100 is coupled to the information server 50 and the measurement server 70 via the Internet 500 to be capable of communicating data with the information server 50 and the measurement server 70 and is also coupled to the sensor node 200 via a wireless communication network to be capable of communicating data with the sensor node 200. The gateway 100 carries out processes such as protocol conversion and the like between the information server 50 and measurement server 70 and the sensor node 200, and also carries out processes as described below.

Based on data representing an event occurrence time acquired from the information server 50, the gateway 100 activates the sensor node 200 at a time earlier by the activation period than the event occurrence time and makes the sensor node 200 acquire measurement data. The gateway 100 acquires the measurement data from the sensor node 200 and transmits the measurement data to the information server 50.

The gateway 100 is an example of an information processing apparatus or a data aggregation apparatus located between the information server 50 and the sensor node 200.

The sensor node 200 incorporates a sensor that detects predetermined data on a predetermined event, and transmits data representing detection values of the sensor to the gateway 100 in accordance with a command received from the gateway 100. The sensor node 200 is an example of a communication node.

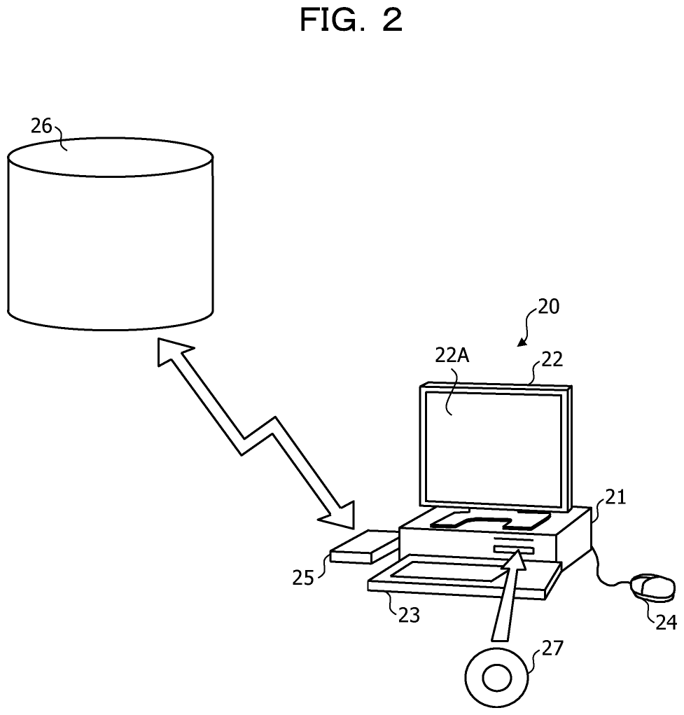

FIG. 2 is a perspective view of a computer system 20 that implements an information server 50. The computer system 20 illustrated in FIG. 2 includes a main body 21, a display 22, a keyboard 23, a mouse 24, and a modem 25.

The main body 21 incorporates a central processing unit (CPU), a hard disk drive (HDD), a disk drive, and the like. The display 22 displays processing results and the like on a screen 22A in accordance with an instruction from the main body 21. The display 22 may be for example a liquid crystal monitor. The keyboard 23 is an input unit for inputting various kinds of information to the computer system 20. The mouse 24 is an input unit for designating a desired position on the screen 22A of the display 22. The modem 25 accesses an external database or the like to download a program or the like stored in another computer system.

A program that provides the computer system 20 with a function as the information server 50 is stored in a portable recording medium such as a disk 27 or downloaded from a recording medium 26 of another computer system by a communication apparatus such as the modem 25, and is inputted to the computer system 20 to be compiled.

The program that provides the computer system 20 with a function as the information server 50 makes the computer system 20 operate as the information server 50. This program may be stored for example in a computer-readable recording medium such as the disk 27. The computer-readable recording medium is not limited to any portable recording medium such as the disk 27, an IC card memory, a magnetic disk such as a floppy (registered trademark) disk, a magneto-optical disk, CD-ROM, or a Universal Serial Bus (USB) memory. The computer-readable recording medium includes various recording media that are accessible by a computer system coupled via a communication apparatus such as the modem 25 or a local area network (LAN).

Although the computer system 20, which implements the information server 50, has been described herein, a computer system that implements the measurement server 70 also has the same configuration. For this reason, the following description will be made on the assumption that the measurement server 70 is also implemented by the computer system 20 illustrated in FIG. 2.

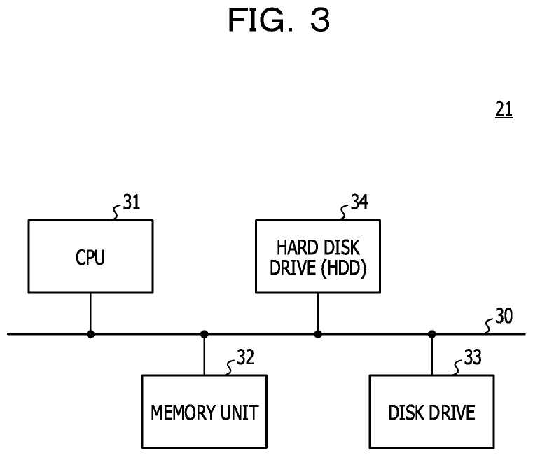

FIG. 3 is a block diagram for explaining a configuration of main parts 21 inside a main body 21 of the computer system 20. The main body 21 includes a CPU 31, a memory unit 32 including a random-access memory (RAM) or a read-only memory (ROM), a disk drive 33 for the disk 27, and a hard disk drive (HDD) 34, which are coupled via a bus 30.

The computer system 20 is not limited to that having the configuration illustrated in FIGS. 2 and 3, and any of various known elements may be added or alternatively used.

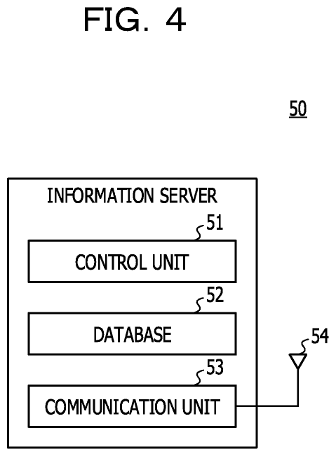

FIG. 4 is a diagram illustrating a configuration of the information server 50. The information server 50 includes a control unit 51, a database 52, a communication unit 53, and an antenna 54. An embodiment in which the vehicle is a car including a fixed-route bus and the information server 50 transmits an event occurrence time to the gateway 100 will be described. A bridge to be measured is designated by an input operation to the keyboard 23 or the mouse 24 of the measurement server 70 (see FIG. 2) and is inputted to the information server 50 via the Internet 500.

The event occurrence time is a time at which the car enters the bridge. The road traffic data held by the information server 50 has position data representing the position (location) of the car traveling each road (each link) contained in map data. The position data changes in real time and is acquired by the information server 50 as data representing movement history of a terminal such as a smartphone terminal having a function of communicating with a Global Positioning System (GPS) apparatus. Such a position data may be acquired from a terminal other than a smartphone terminal as long as the terminal has a function of communicating with a GPS apparatus.

Since the speed of the car may be obtained from the change in position data over time, it is possible to predict the time at which the car will enter the bridge to be measured in advance. The position data includes not only that of a car but also those of a pedestrian, a bicycle, and the like. For this reason, position data with a speed equal to or greater than a predetermined speed (for example, 30 km/h) may be handled as position data of a car, for example. In this way, it is possible to acquire the time at which a car will enter the bridge (event occurrence time) from the road traffic data.

The event occurrence time may be acquired from the schedule data. For example, in the case where there is a fixed-route bus whose travel route contains a predetermined bridge to be measured, it is possible to identify the time slot in which the fixed-route bus will pass through the bridge by using schedules of two bus stops before and after the bridge.

Since it is impossible to obtain the time at which the fixed-route bus will pass through the bridge directly from the schedule data, the schedule represented by the schedule data of the bus stop located before the bridge in the traveling direction of the fixed-route bus among schedules of two bus stops before and after the bridge to be measured is handled as the time at which the fixed-route bus will pass through the bridge.

Specifically, for example, handled as the event occurrence time is the departure time of the fixed-route bus contained in the schedule data of the bus stop before the bridge in the traveling direction among schedules of two bus stops of the fixed-route bus before and after the bridge to be measured.

The control unit 51 calculates the time at which the car that will pass through the bridge to be measured will enter the bridge and transmits the time to the gateway 100. The control unit 51 extracts the schedule data of two bus stops before and after the bridge to be measured from the database 52 and transmits the schedule data to the gateway 100 via the communication unit 53.

The database 52 stores the schedule data, the road traffic data, and the like. Among these, regarding the schedule data, the database 52 may be configured to store schedule data of a plurality of bus stops included in a predetermined region in advance. In this case, the control unit 51 may extract the schedule data of two bus stops, which are inputted through the keyboard 23 or the mouse 24 (see FIG. 2), from a plurality of schedule data stored in the database 52 in advance.

A possible configuration is such that the control unit 51 downloads schedule data of two bus stops, which are inputted through the keyboard 23 or the mouse 24 of the measurement server 70 (see FIG. 2), from the website or the like of the bus company via the Internet 500, and the database 52 stores the schedule data thus downloaded. The database 52 may store schedule data in a configuration combining these two configurations.

The communication unit 53 is a modem or the like coupled to the Internet 500 via the antenna 54.

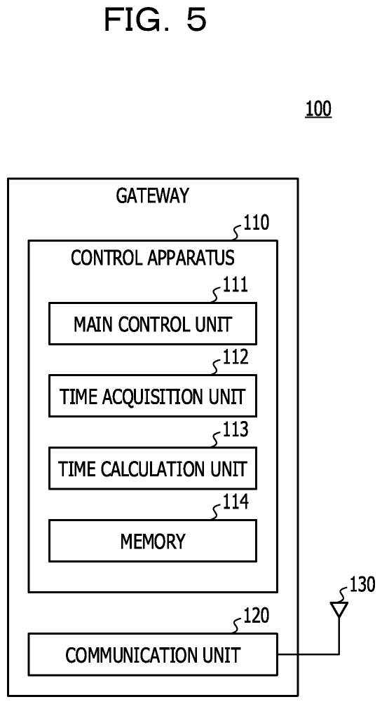

FIG. 5 is a diagram illustrating a configuration of the gateway 100. The gateway 100 includes a control apparatus 110, a communication unit 120, and an antenna 130.

The control apparatus 110 is implemented by a computer system including a CPU, a memory unit including a RAM or a ROM, a hard disk drive (HDD), and the like. The configuration of the control apparatus 110 as a computer system is the same as that of the computer system 20 illustrated in FIG. 3.

The control apparatus 110 includes a main control unit 111, a time acquisition unit 112, a time calculation unit 113, and a memory 114. The main control unit 111, the time acquisition unit 112, and the time calculation unit 113 are expressed by representing functions of a program executed by the control apparatus 110 as functional blocks. The memory 114 is expressed by functionally representing the memory of the control apparatus 110.

The main control unit 111 is a processing unit that integrates the control of the gateway 100 and executes processes other than those executed by the time acquisition unit 112 and the time calculation unit 113. The main control unit 111, for example, conducts processes of transmitting a boot start time and a measurement period to the sensor node 200 and transmitting measurement data to the measurement server 70, and the like.

The time acquisition unit 112 acquires an event occurrence time. More specifically, for example, the time acquisition unit 112 acquires the time at which the car will enter the bridge and the schedule data from the information server 50. The schedule data acquired by the time acquisition unit 112 is data representing schedules of two bus stops of the fixed-route bus before and after the bridge a vibration of which is to be measured by the sensor node 200.

The time calculation unit 113 obtains the boot start time by subtracting the boot period of the sensor node 200 from the time at which the car will enter the bridge. The boot start time represents a time at which the sensor node 200 starts booting (boot start time). The boot start time is an example of an activation start time.

The time calculation unit 113 generates a timetable by subtracting the boot period of the sensor node 200 from the schedule represented by the schedule data of the bus stop located before the bridge among two schedule data acquired by the time acquisition unit 112. The timetable represents a time at which the sensor node 200 starts booting (boot start time).

The memory 114 stores a program and data to be used by the gateway 100 to conduct processes and temporarily stores data representing detection values received from the sensor node 200. The memory 114 stores other data and the like to be used by the gateway 100 to conduct processes.

The communication unit 120 transmits and receives data to and from the information server 50 via the antenna 130. The communication unit 120 also transmits a measurement command and a switch command to the sensor node 200 via the antenna 130 and receives various notifications and data (acceleration data) from the sensor node 200. The communication unit 120 is an example of a first communication unit.

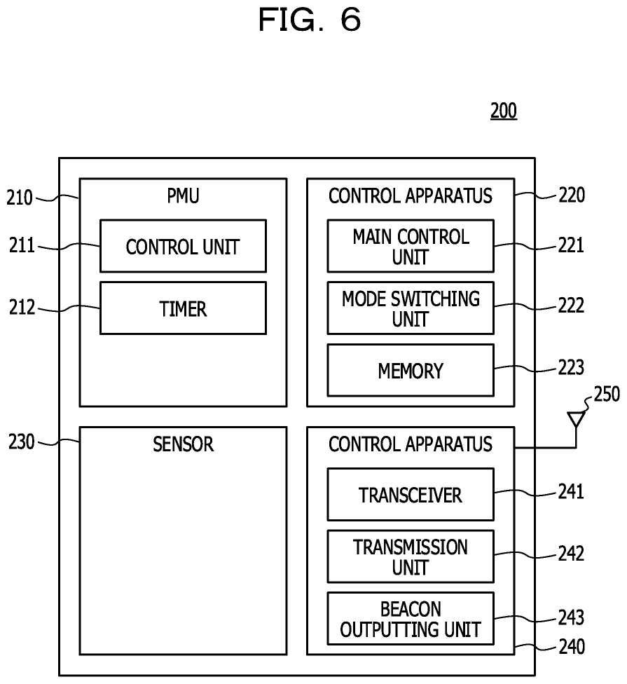

FIG. 6 is a diagram illustrating a configuration of the sensor node 200. The sensor node 200 includes a Power Management Unit (PMU) 210, a control apparatus 220, a sensor 230, a communication unit 240, and an antenna 250. The sensor node 200 is supplied with electric power from an external electric power source.

The PMU 210 includes a control unit 211 and a timer 212. The PMU 210 allocates electric power supplied from the external electric power source to the control apparatus 220, the sensor 230, and the communication unit 240. The PMU 210 allocates electric power depending on the mode set by the control apparatus 220. The allocation is controlled by the control unit 211 of the PMU 210. The timer 212 counts sleep period in a sleep mode.

The control apparatus 220 is a processing unit that performs control in the sensor node 200 and is implemented by a microcomputer. The microcomputer includes a CPU and a memory unit including a RAM, a ROM, or the like.

The control apparatus 220 includes a main control unit 221, a mode switching unit 222, and a memory 223. The main control unit 221 and the mode switching unit 222 are expressed by representing functions of a program executed by the control apparatus 220 as functional blocks. The memory 223 is expressed by functionally representing the memory of the control apparatus 220.

The main control unit 221 is a processing unit that integrates the control of the sensor node 200 and executes processes other than those executed by the mode switching unit 222. For example, the main control unit 221 acquires data representing a detection value of the sensor 230 in accordance with a measurement command received from the gateway 100 and transmits the data to the gateway 100. The main control unit 221 is an example of a data acquisition unit.

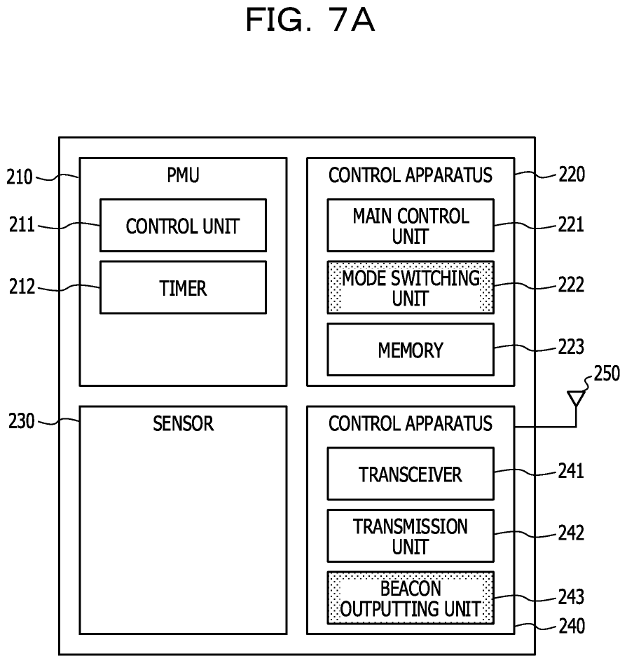

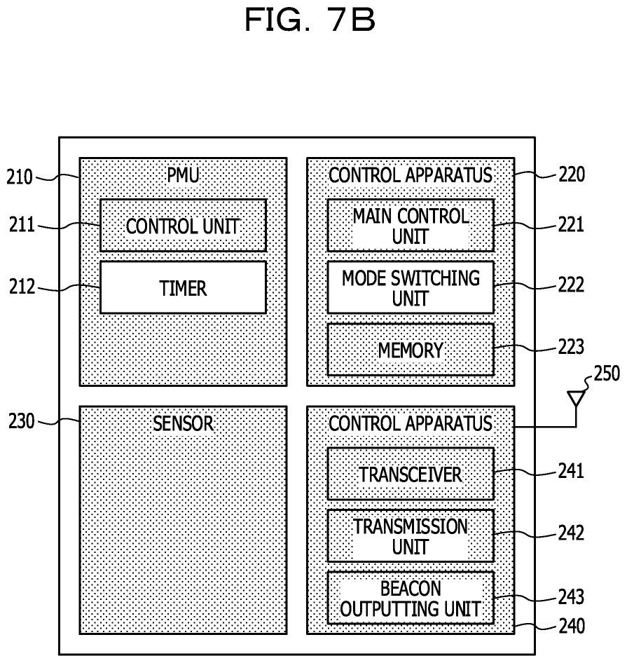

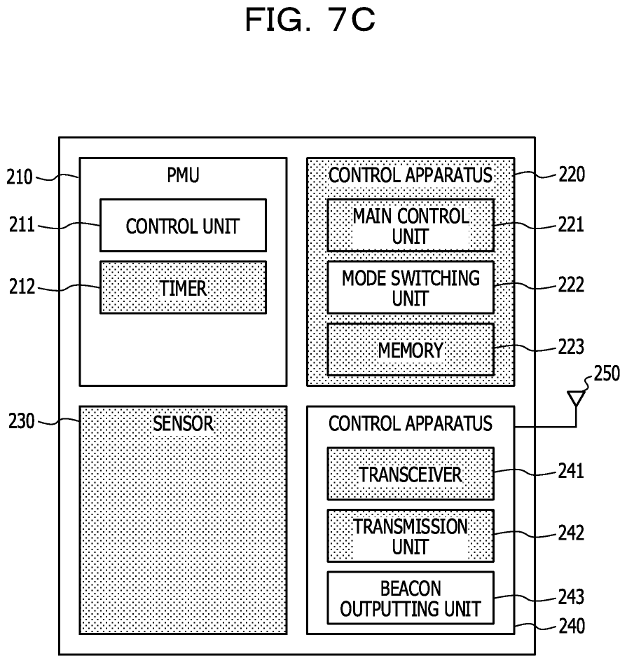

The mode switching unit 222 sets the mode of the sensor node 200 to one of an activation mode, a sleep mode, and a partial sleep mode in accordance with a switch command received from the gateway 100. These modes will be described later with reference to FIGS. 7A to 7C.

The memory 223 stores a program and data to be used by the sensor node 200 to conduct processes and temporarily stores data representing detection values of the sensor 230. The memory 223 stores other data and the like to be used by the sensor node 200 to conduct processes.

The sensor 230 is for example a 3-axis accelerometer and detects accelerations in 3 axial (XYZ) directions. The sensor 230 detects accelerations in the 3 axial directions in accordance with an instruction inputted from the main control unit 221 of the control apparatus 220 and outputs data representing the detected accelerations (acceleration data) to the communication unit 240.

The communication unit 240 includes a transceiver 241, a transmission unit 242, and a beacon outputting unit 243 and is coupled to the antenna 250. The communication unit 240 is an example of a second communication unit. The transceiver 241 transmits and receives data to and from the gateway 100 via the antenna 250. The transceiver 241 receives a measurement command and a switch command from the gateway 100 and transmits a activation completion notification indicating that the activation of the sensor node 200 has been completed, a sampling completion notification indicating that the sampling (measurement) of data (acceleration data) has been completed, and the like to the gateway 100.

The transmission unit 242 transmits data (acceleration data) detected by the sensor 230 to the gateway 100 via the antenna 250. The beacon outputting unit 243 emits beacon signals via the antenna 250. The beacon signal contains the identifier (ID) of each sensor node 200. The sensor node 200 causes the beacon outputting unit 243 to emit a beacon signal when requesting a command to the gateway 100, and the like.

The antenna 250 may be any antenna that is capable of transmitting and receiving data and the like of the transceiver 241, the transmission unit 242, and the beacon outputting unit 243. The antenna 250 is one or a plurality of antennas according to the format of data and the like, communication specifications, and the like.

FIGS. 7A to 7C are diagrams for explaining modes of the sensor node 200. The mode of the sensor node 200 is set to one of the activation mode, the sleep mode, and the partial sleep mode by the mode switching unit 222 in accordance with a switch command received from the gateway 100.

In the activation mode illustrated in FIG. 7A, the PMU 210, the control apparatus 220, the sensor 230, and the communication unit 240 are activated (in activated states (on states)) except for the mode switching unit 222 and the beacon outputting unit 243. For this reason, in FIG. 7A, the PMU 210, the control apparatus 220, the sensor 230, and the communication unit 240, except for the mode switching unit 222 and the beacon outputting unit 243, are illustrated in white while the mode switching unit 222 and the beacon outputting unit 243 are illustrated in gray. In the activation mode, the sensor node 200 samples data (acceleration data) utilizing the sensor 230.

In the sleep mode illustrated in FIG. 7B, the PMU 210, the control apparatus 220, the sensor 230, and the communication unit 240 are not activated (in sleeping states) except for the timer 212 and the mode switching unit 222. For this reason, in FIG. 7B, the PMU 210, the control apparatus 220, the sensor 230, and the communication unit 240 are illustrated in gray while the timer 212 and the mode switching unit 222, which are on, are illustrated in white.

In the sleep mode, the timer 212 counts the sleep period, and once the counting of the sleep period is completed, the timer 212 transmits reset signals to the control apparatus 220, the sensor 230, and the communication unit 240, and the sensor node 200 is in the activation mode until the measurement period is completed. Once the measurement period is completed, the sensor node 200 ends the activation mode and is returned to the sleep mode.

In the partial sleep mode illustrated in FIG. 7C, the PMU 210 and the communication unit 240 are activated (in activated states (on states)) except for the timer 212, the transceiver 241, and the transmission unit 242 while the control apparatus 220 and the sensor 230 are not activated (in sleeping states). For this reason, in FIG. 7C, the PMU 210 and the communication unit 240 are illustrated in white while the timer 212, the transceiver 241, the transmission unit 242, the control apparatus 220, and the sensor 230, which are off, are illustrated in gray. In this way, the partial sleep mode is a state where the PMU 210 and the communication unit 240 are activated while the control apparatus 220 and the sensor 230 are not activated.

In the partial sleep mode, when the communication unit 240 receives an activation instruction from the gateway 100, the control apparatus 220 and the sensor 230 are activated and the sensor node 200 is in the activation mode until the measurement period is completed. Once the measurement period is completed, the sensor node 200 ends the activation mode and is returned to the partial sleep mode.

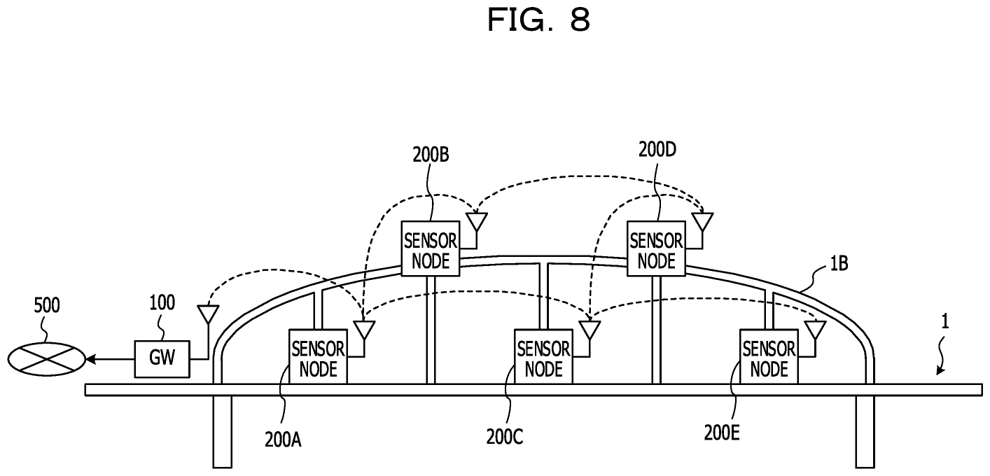

FIG. 8 is a diagram illustrating an example of installation locations of the gateway 100 and the sensor node 200. The gateway (GW) 100 and a plurality of the sensor nodes 200 are installed in a bridge 1 as an example. Hereinafter, when distinguished, the plurality of sensor nodes 200 are called sensor nodes 200A, 200B, 200C, 200D, and 200E while when not distinguished the plurality of sensor nodes 200 are simply called sensor nodes 200.

In FIG. 8, the gateway 100 is installed on one end side of a bridge girder 1A of the bridge 1, the sensor nodes 200A, 200C, and 200E are installed on the bridge girder 1A, and the sensor nodes 200B and 200D are installed on an arch 1B.

The sensor node 200A communicates directly with the gateway 100, the sensor nodes 200B and 200C communicate with the sensor node 200A, and the sensor nodes 200D and 200E communicate with the sensor nodes 200B and 200C. In this way, the sensor nodes 200A to 200E construct a network structure that may be regarded as a mesh structure.

The sensors 230 of the sensor nodes 200A to 200E measure acceleration of vibration generated in the bridge 1 as a car passes through the bridge 1. While the vibration of the bridge 1 is vibration having a natural frequency, the frequency of the vibration varies if a damaged portion such as a crack exists in the bridge girder 1A, the arch 1B, or the like of the bridge 1. The data collection system 10 is provided to find out such abnormality of the bridge 1.

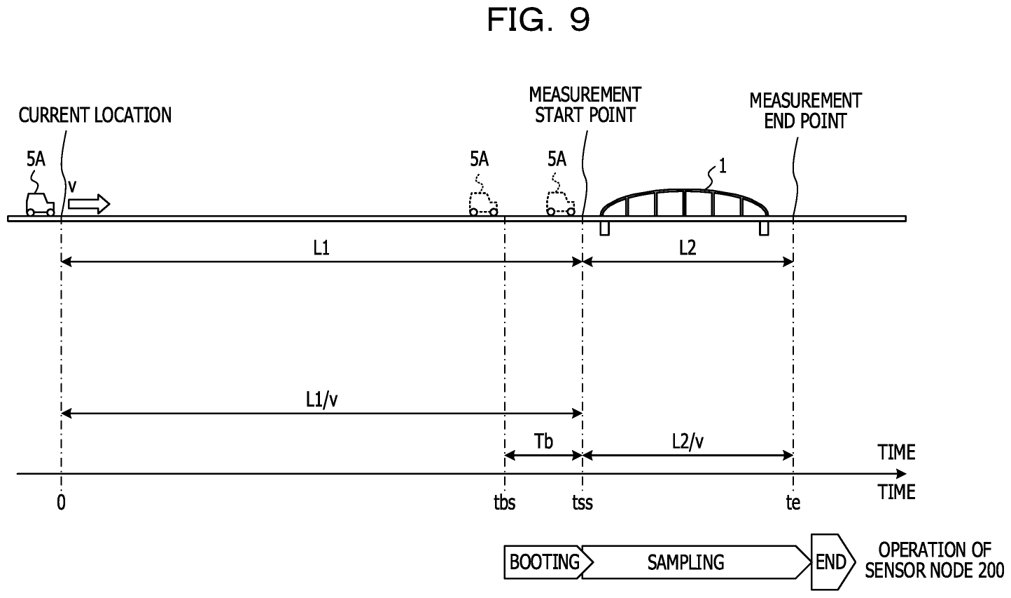

FIG. 9 is a diagram for explaining a measurement approach utilizing the partial sleep mode of the sensor node 200. An approach in which the sensor node 200 switches from the partial sleep mode to the activation mode to sample data will be described.

The control unit 51 of the information server 50 extracts the speed v of a car 5A from a change over time of position data contained in the road traffic data and extracts a distance L1 from the current location of the car 5A to a measurement start point immediately before the bridge 1 and a distance L2 from the measurement start point to a measurement end point immediately after the bridge 1 by utilizing the map data contained in the road traffic data. The control unit 51 obtains a taken period (L/v) taken for the car 5A to reach the measurement start point and obtains a time tss at which the car 5A will enter the bridge 1 by adding the taken period to a current time. The control unit 51 obtains a measurement period (L2/v) from the measurement start point to the measurement end point.

Data representing the time tss and the measurement period (L2/v) from the measurement start point to the measurement end point, obtained by the control unit 51, is transmitted from the information server 50 to the gateway 100. A time obtained by adding the measurement period (L2/v) to the time tss at which the car 5A will enter the bridge 1 is called a measurement end time te.

The time acquisition unit 112 of the control apparatus 110 of the gateway 100 acquires the time tss at which the car 5A will enter the bridge 1, and the time calculation unit 113 obtains a boot start time tbs by subtracting the boot period Tb from the time tss.

The main control unit 111 transmits an activation instruction to the sensor node 200 at the boot start time tbs. The time tss is a time tss at which the car 5A will enter the bridge 1 and is also a time at which the sensor node 200 will start sampling.

The sensor node 200 is thus switched to the activation mode to start booting upon receipt of the activation instruction at the boot start time tbs, samples data from the time tss at which the car 5A enters the bridge 1 over the measurement period (L2/v), and ends the sampling at the measurement end time te. Once ending the sampling, the sensor node 200 returns to the partial sleep mode. The process of sampling as illustrated in FIG. 9 is conducted when the partial sleep mode is selected.

The boot period Tb is a time taken for all of the plurality of sensor nodes 200 to complete booting, and an actual measured value is used while a predetermined margin (margin period) may be contained. The margin is for example approximately 10% of the measured period. If an actually measured period is used in setting the boot period Tb, a delay time taken for the sensor node 200D or 200E, which is last activated, to complete activation relative to the sensor node 200A, which is first activated, is contained in the boot period Tb. This makes it possible to start measurement after the activation of the sensor node 200D or 200E, which is last activated among the sensor nodes 200A to 200E coupled in a mesh structure, is completed. The same applies to a case where a plurality of sensor nodes 200 are coupled in a tree structure.

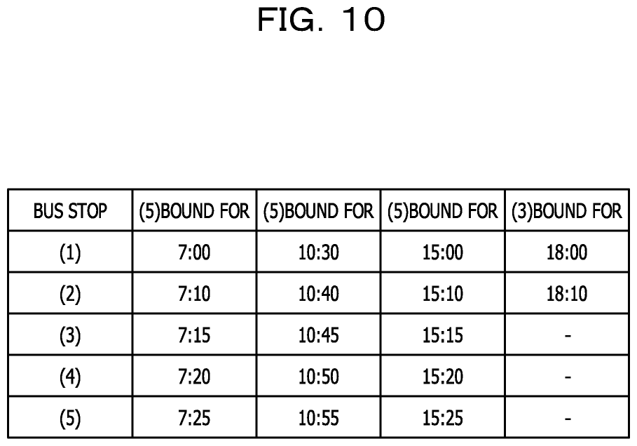

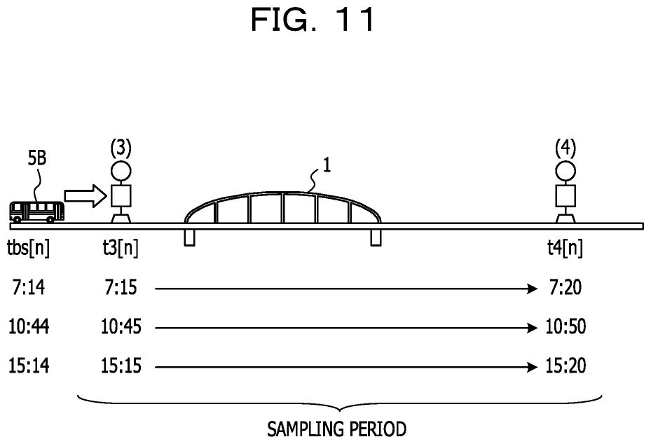

FIG. 10 is a diagram illustrating an example of schedule data. There are bus stops (1) to (5) for fixed-route buses 5B and there are fixed-route buses 5B bound for the bus stop (5) and bound for the bus stop (3). FIG. 11 is a diagram for explaining a measurement approach utilizing the sleep mode. An approach in which the sensor node 200 switches from the sleep mode to the activation mode to sample data will be described.

In a case where the bridge 1 exists between the bus stops (3) and (4), the departure time t3[n] at the bus stop (3) is 7:15, 10:45, and 15:15 and the departure time t4[n] at the bus stop (4) is 7:20, 10:55, and 15:20 in the schedule.

Here, n in the departure times t3[n] and t4[n] is an integer of 0 or more and indicates which one the departure is as counted from the first departure. Thus, at the bus stop (3), the departure time t3[0] of the first departure is 7:15, the departure time t3[1] of the second departure is 10:45, and the departure time t3[2] of the third departure is 15:15. At the bus stop (4), the departure time t4[0] of the first departure is 7:20, the departure time t4[1] of the second departure is 10:50, and the departure time t4[2] of the third departure is 15:20.

The control unit 51 of the information server 50 transmits the schedule data of the bus stops (3) and (4) to the gateway 100.

Upon receipt of two schedule data, the time acquisition unit 112 of the control apparatus 110 of the gateway 100 reads the departure time t3[n] from the schedule data of the bus stop (3) before the bridge 1, and the time calculation unit 113 generates a timetable containing the boot start time tbs[n] by subtracting the boot period Tb from the departure time t3[n].

In a case where the boot period Tb is 1 minute, the boot start time tbs[0] of the first departure is 7:14, the boot start time tbs[1] of the second departure is 10:44, and the boot start time tbs[2] of the third departure is 15:14.

The time calculation unit 113 obtains the measurement period. The measurement period is a period from the departure time t3[n] at the bus stop (3) immediately before the bridge 1 to the departure time t4[n] at the bus stop (4) immediately after the bridge 1 and is 5 minutes.

The main control unit 111 transmits the boot start time tbs[n] and the measurement period to the sensor node 200.

As a result, booting is started at the boot start time tbs[n] by the sensor node 200 and sampling is started at a time at which the boot period Tb has elapsed, and the sampling is conducted over the measurement period. The process of sampling as illustrated in FIG. 10 is conducted when the sleep mode is selected.

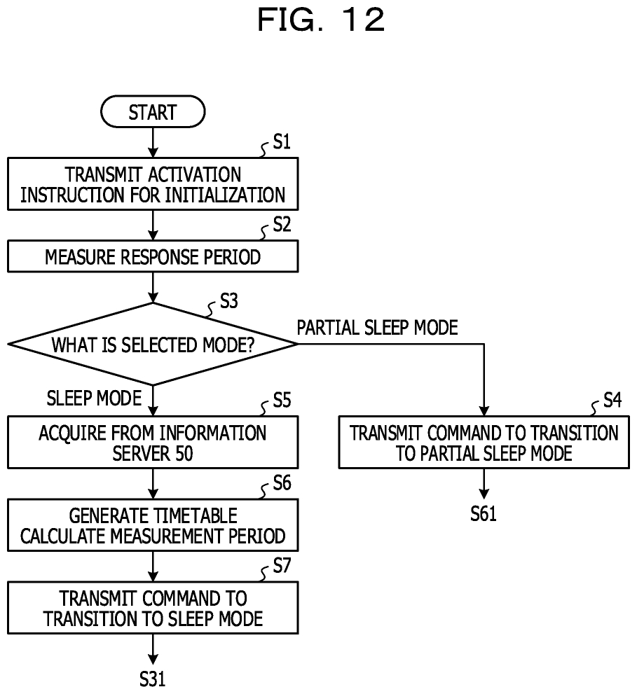

FIG. 12 is a flowchart illustrating a process in which the control apparatus 110 of the gateway 100 initializes the sensor nodes 200A to 200E. It is assumed as premises that the sampling of data (acceleration data) representing vibrations at the sensor nodes 200A to 200E when the car 5A (including the fixed-route bus 5B) will pass through the bridge 1 between the bus stops (3) and (4) has been inputted to the measurement server 70 and the information server 50 and the gateway 100 have been notified of this.

The main control unit 111 starts the process upon receipt of a command to start the process from the measurement server 70.

The main control unit 111 transmits an activation instruction for initialization to all the sensor nodes 200A to 200E (Step S1). The activation instruction for initialization is an instruction to cause the sensor nodes 200A to 200E to start booting for conducting initialization. Upon receipt of the activation instruction for initialization, the sensor nodes 200A to 200E start booting, and upon completion of the booting, transmit activation completion notifications to the gateway 100.

The main control unit 111 measures a response period from when the main control unit 111 transmits the activation instruction for initialization to all the sensor nodes 200A to 200E in Step S1 to when the main control unit 111 receives the activation completion notifications from the sensor nodes 200A to 200E (Step S2). The response period with respect to the activation instruction for initialization is measured to be used as the boot period Tb for the entire network of the sensor nodes 200A to 200E.

In the case where 5 sensor nodes 200A to 200E are coupled in a mesh structure as illustrated in FIG. 8, the activation completion notifications of the sensor nodes 200B to 200E are received via the sensor node 200A closest to the gateway 100.

The response period to be measured in Step S2 is a period from when the activation instructions for initialization are transmitted to the sensor nodes 200A to 200E to when the booting of the sensor nodes 200A to 200E is completed and all the activation completion notifications are received by the gateway 100. The response period is thus little longer than a period from when the activation instructions for initialization are transmitted to the sensor nodes 200A to 200E to when the booting of the sensor nodes 200A to 200E is completed. Hence, the response period is favorably used as the boot period Tb for the entire network of the sensor nodes 200A to 200E.

The main control unit 111 determines whether a selected mode inputted from the measurement server 70 is the sleep mode or the partial sleep mode (Step S3). The selected mode is a mode that is selected by the user and inputted to the measurement server 70 among the sleep mode and the partial sleep mode. The user may select the sleep mode or the partial sleep mode depending on the traffic of the car 5A on the road and/or the easiness of acquiring data in the sleep mode and in the partial sleep mode, and the like.

If the main control unit 111 determines that the partial sleep mode has been selected in Step S3, the main control unit 111 transmits a command to transition to the partial sleep mode to the sensor nodes 200A to 200E (Step S4). As a result, the sensor nodes 200A to 200E transition to the partial sleep mode illustrated in FIG. 7C.

If the main control unit 111 determines that the sleep mode has been selected in Step S3, the time acquisition unit 112 requests the information server 50 to transmit two schedule data and acquires the two schedule data from the information server 50 (Step S5).

Once the time acquisition unit 112 acquires the two schedule data, the time calculation unit 113 generates timetable containing the boot start time tbs[n] by subtracting the boot period Tb from the departure time t3[n], and calculates a measurement period from the two schedule data (Step S6).

The main control unit 111 transmits a command to transition to the sleep mode until the boot start time tbs[n] to the sensor nodes 200A to 200E (Step S7). At the boot start time tbs[n], the sensor nodes 200A to 200E is turned to the activation mode until the measurement period ends.

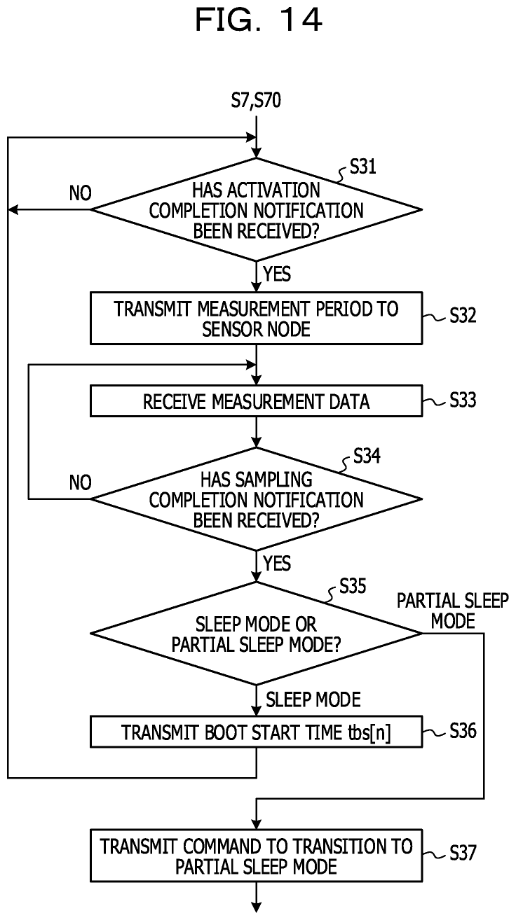

Upon completion of the process of Step S7, the main control unit 111 advances the flow to Step S31 (see FIG. 14).

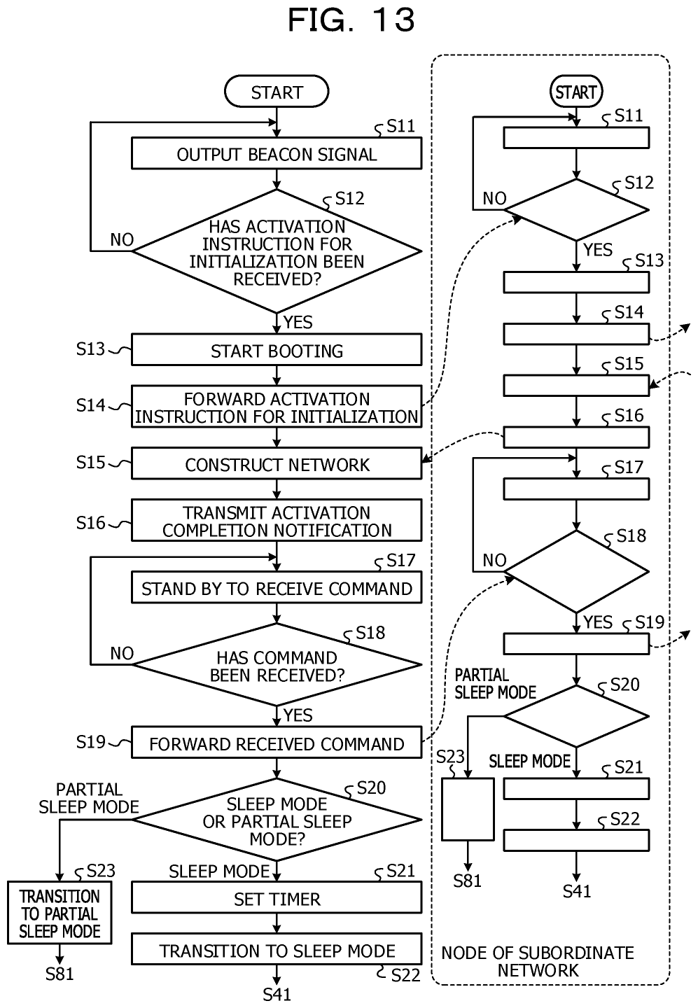

FIG. 13 is a flowchart illustrating a process of initializing the sensor nodes 200A to 200E. In FIG. 13, two flowcharts with the same content are illustrated side by side on the left and right and wordings in the right flowchart are omitted. The flowchart on the left side illustrates the process conducted by the sensor node 200A, which communicates directly with the gateway 100, while the flowchart on the right side illustrates the process conducted by the sensor nodes 200B to 200E, which communicate with the sensor node 200A.

The process will be described as the process of the sensor node 200A. The process will be described under the same premises as those of the process of the gateway 100 illustrated in FIG. 12.

Once the electric power source of the sensor node 200A is turned on, the main control unit 221 starts the process.

The main control unit 221 causes the beacon outputting unit 243 to output beacon signals (Step S11). The beacon outputting unit 243 outputs beacon signals from the antenna 250 every predetermined time (for example, 1 second).

The main control unit 221 determines whether the main control unit 221 has received the activation instruction for initialization from the gateway 100 (Step S12). The main control unit 221 repeatedly executes the processes of Steps S11 and S12 until the main control unit 221 receives the activation instruction for initialization.

If the main control unit 221 determines that the main control unit 221 has received the activation instruction for initialization (S12: YES), the main control unit 221 starts booting (Step S13).

The main control unit 221 forwards the activation instruction for initialization to the other sensor nodes 200B to 200E in order to construct the network with the other sensor nodes 200B to 200E (Step S14).

Upon receipt of the activation completion notifications indicating that the booting has been completed from all the other sensor nodes 200B to 200E, the main control unit 221 constructs the network with all the other sensor nodes 200B to 200E (Step S15). In the process of Step S15, the sensor nodes 200 within the communication range construct the network. In this way, the network having a mesh structure as illustrated in FIG. 8 is constructed.

The main control unit 221 transmits an activation completion notification indicating that the booting of the sensor nodes 200A to 200E has been completed to the gateway 100 (Step S16).

The main control unit 221 stands by in order to receive a command from the gateway 100 (Step S17). At this time, the sensor nodes 200A to 200E are in the activation state of FIG. 7A.

The main control unit 221 determines whether the main control unit 221 has received a command from the gateway 100 (Step S18). If the main control unit 221 determines that the main control unit 221 has not received a command from the gateway 100 (S18: NO), the main control unit 221 returns the flow to Step S17. As a result, the main control unit 221 repeatedly executes the processes of Steps S17 and S18 until the main control unit 221 receives a command to transition to the sleep mode or the partial sleep mode from the gateway 100.

If the main control unit 221 determines that the main control unit 221 has received a command to transition to the sleep mode or the partial sleep mode from the gateway 100 (S18: YES), the main control unit 221 forwards the received command to the other sensor nodes 200B to 200E (Step S19).

The main control unit 221 determines whether the received command is the sleep mode or the partial sleep mode (Step S20).

If the main control unit 221 determines that the received command is the sleep mode in Step S20, the main control unit 221 sets the timer 212 of the PMU 210 so as to wake up at the boot start time tbs[n] (Step S21).

Upon completion of the setting of the timer 212, the main control unit 221 transitions to the sleep mode (Step S22). In this way, the sensor node 200A is turned to the sleep mode.

If the main control unit 221 determines that the received command is the partial sleep mode in Step S20, the main control unit 221 transitions to the partial sleep mode (Step S23). In this way, the sensor node 200A is turned to the partial sleep mode. The switching of the modes is conducted by the mode switching unit 222.

FIG. 14 is a flowchart illustrating processes executed by the gateway 100. The processes illustrated in FIG. 14 are processes subsequent to Step S7 illustrated in FIG. 12, and start from the state where the sensor nodes 200A to 200E are set in the sleep mode.

The main control unit 111 determines whether the main control unit 111 has received an activation completion notification from the sensor node 200A (Step S31). The activation completion notification transmitted from the sensor node 200A is an activation completion notification indicating that the booting of all the sensor nodes 200A to 200E has been completed.

The main control unit 111 transmits a measurement period to the sensor nodes 200A to 200E (Step S32). The measurement period is a period from the departure time t3[n] at the bus stop (3) immediately before the bridge 1 to the departure time t4[n] at the bus stop (4) immediately after the bridge 1 and is 5 minutes.

The main control unit 111 receives measurement data from the sensor node 200A (Step S33).

The main control unit 111 determines whether the main control unit 111 has received a sampling completion notification from the sensor node 200A (Step S34). The sampling completion notification which the gateway 100 receives from the sensor node 200A is a notification indicating that the sampling by the sensor nodes 200A to 200E has been completed. If the main control unit 111 determines that the main control unit 111 has not received a sampling completion notification (S34: NO), the main control unit 111 returns the flow to Step S33.

The main control unit 111 determines whether a selected mode inputted from the measurement server 70 is the sleep mode or the partial sleep mode (Step S35).

If the main control unit 111 determines that the sleep mode has been selected in Step S35, the main control unit 111 transmits the boot start time tbs[n] (Step S36). The boot start time tbs[n] set in Step S36 is a boot start time corresponding to a fixed-route bus 5B that is one bus after the boot start time tbs[n] set in Step S21 in the schedule of the fixed-route bus 5B.

Upon completion of the process of Step S36, the main control unit 111 returns the flow to Step S31. In this way, the sleep mode is continued.

On the other hand, if the main control unit 111 determines that the partial sleep mode has been selected in Step S35, the main control unit 111 transmits a command to transition to the partial sleep mode to the sensor nodes 200A to 200E (Step S37). As a result, all the sensor nodes 200A to 200E transition to the partial sleep mode illustrated in FIG. 7C.

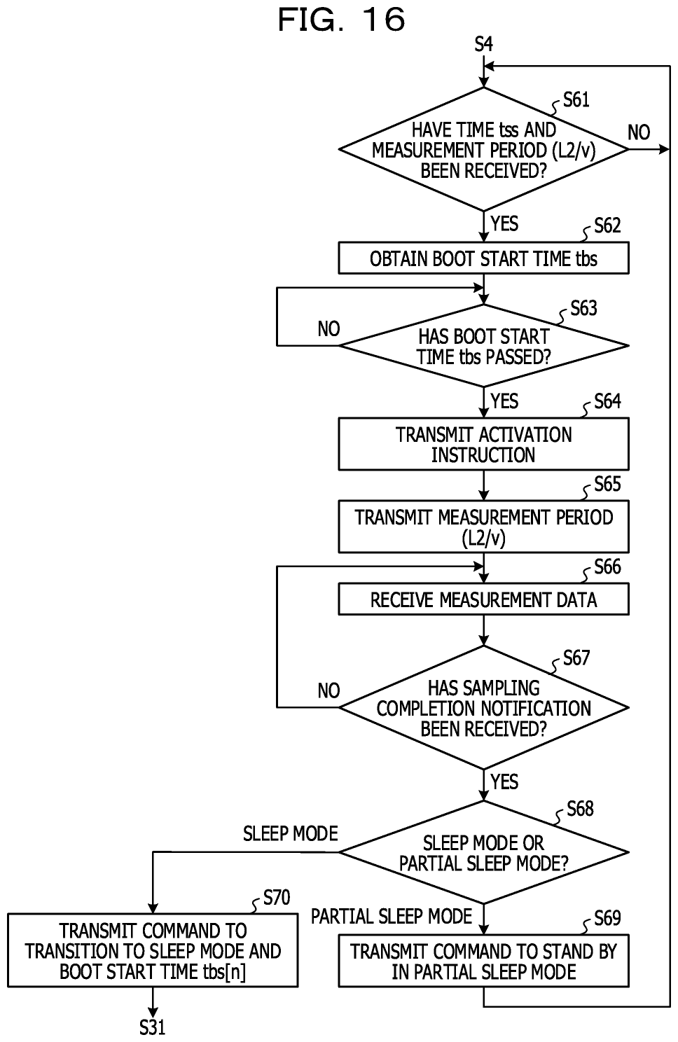

Upon completion of the process of Step S37, the main control unit 111 advances the flow to Step S61 (see FIG. 16).

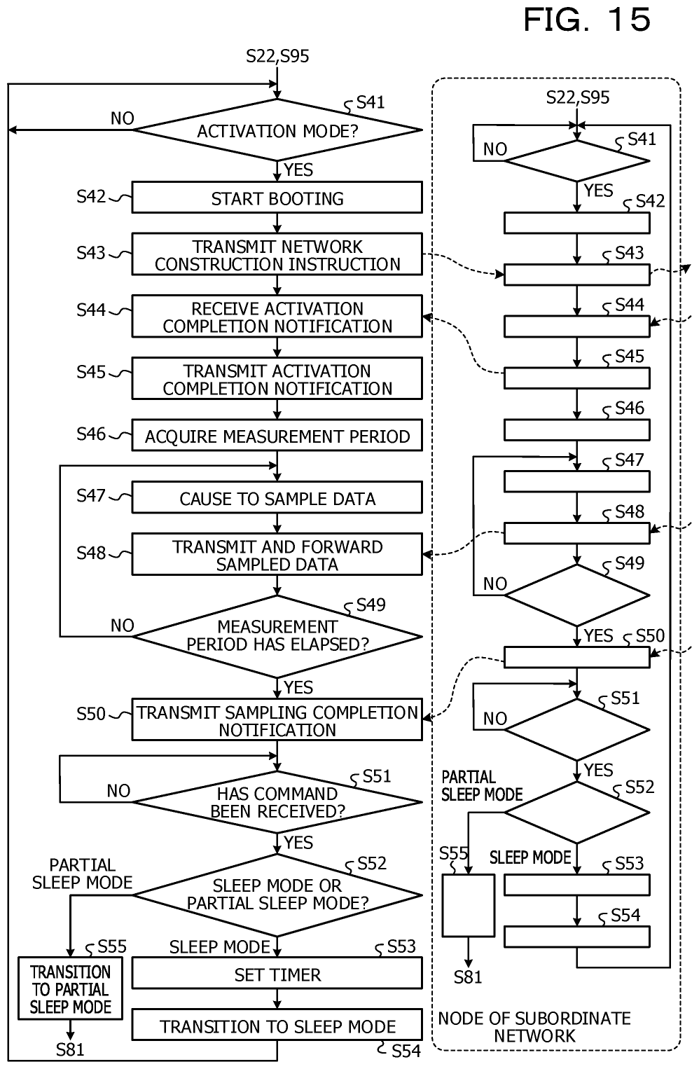

FIG. 15 is a flowchart illustrating processes executed by the sensor nodes 200A to 200E. The processes illustrated in FIG. 15 are processes subsequent to Step S22 illustrated in FIG. 13, and start from the state where the sensor nodes 200A to 200E are set in the sleep mode. In FIG. 15, the processes of the sensor node 200A will be described as in the case of FIG. 13.

Once a reset signal is outputted from the timer 212 and the mode switching unit 222 switches the mode from the sleep mode to the activation mode, the main control unit 221 determines whether the mode is the activation mode (Step S41). The process of Step S41 is repeatedly executed until it is determined that the mode is the activation mode.

Upon completion of the counting of the sleep period (upon wake up at the boot start time tbs[n]), the timer 212 transmits a reset signal to the control apparatus 220, the sensor 230, and the communication unit 240. In this way, the mode is switched from the sleep mode to the activation mode by the mode switching unit 222.

If the main control unit 221 determines that the mode is the activation mode (S41: YES), the main control unit 221 starts booting (Step S42). The time at which the booting is started is the boot start time tbs[n].

The main control unit 221 transmits a network construction instruction to the other sensor nodes 200B to 200E in order to construct the network with the other sensor nodes 200B to 200E (Step S43). The sensor nodes 200B to 200E have already started booting. Upon receipt of the network construction instruction, the sensor nodes 200B to 200E forward the network construction instruction and construct the network with the sensor node 200 that is within the communication range after completion of booting.

The main control unit 221 receives an activation completion notification indicating that the booting of all the other sensor nodes 200B to 200E has been completed (Step S44). In this state, the network of the sensor nodes 200A to 200E has been constructed.

The main control unit 221 transmits an activation completion notification indicating that the booting of the sensor nodes 200A to 200E has been completed to the gateway 100 (Step S45).

The main control unit 221 acquires a measurement period from the gateway 100 (Step S46). The measurement period is a period from the departure time t3[n] at the bus stop (3) immediately before the bridge 1 to the departure time t4[n] at the bus stop (4) immediately after the bridge 1 and is 5 minutes. The main control unit 221 starts counting 5 minutes with the timer.

The main control unit 221 causes the sensor 230 to sample data (Step S47).

The main control unit 221 transmits data sampled by the sensor 230 of the sensor node 200A to the gateway 100 and forwards (relays) data sampled by the sensors 230 of the sensor nodes 200B to 200E to the gateway 100 (Step S48).

The main control unit 221 determines whether the measurement period has elapsed (Step S49). If the main control unit 221 determines that the measurement period has not elapsed (S49: NO), the main control unit 221 returns the flow to Step S47. As a result, the processes of Steps S47 to S49 are repeatedly executed, so that data is sampled by the sensors 230 of the sensor nodes 200A to 200E.

If the main control unit 221 determines that the measurement period has elapsed in Step S49 (S49: YES), the main control unit 221 transmits a sampling completion notification indicating that sampling by the sensor nodes 200A to 200E has been completed to the gateway 100 (Step S50).

The main control unit 221 determines whether the main control unit 221 has received a command from the gateway 100 (Step S51). If the main control unit 221 determines that the main control unit 221 has not received a command from the gateway 100 (S51: NO), the main control unit 221 repeatedly executes the process of Step S51.

The main control unit 221 determines whether the received command is the sleep mode or the partial sleep mode (Step S52). If the main control unit 221 determines that the received command is the sleep mode in Step S52, the main control unit 221 sets the timer 212 so as to wake up at the boot start time tbs[n] (Step S53). The boot start time tbs[n] set in Step S53 is the boot start time tbs[n] which the gateway 100 transmitted to the sensor node 200 in Step S36.

The main control unit 221 transitions to the sleep mode (Step S54). In this way, the sensor node 200A transitions to the sleep mode. The switching of the modes is conducted by the mode switching unit 222.

On the other hand, if the main control unit 221 determines that the received command is the partial sleep mode in Step S52, the main control unit 221 transitions to the partial sleep mode (Step S55). In this way, the sensor node 200A transitions to the partial sleep mode.

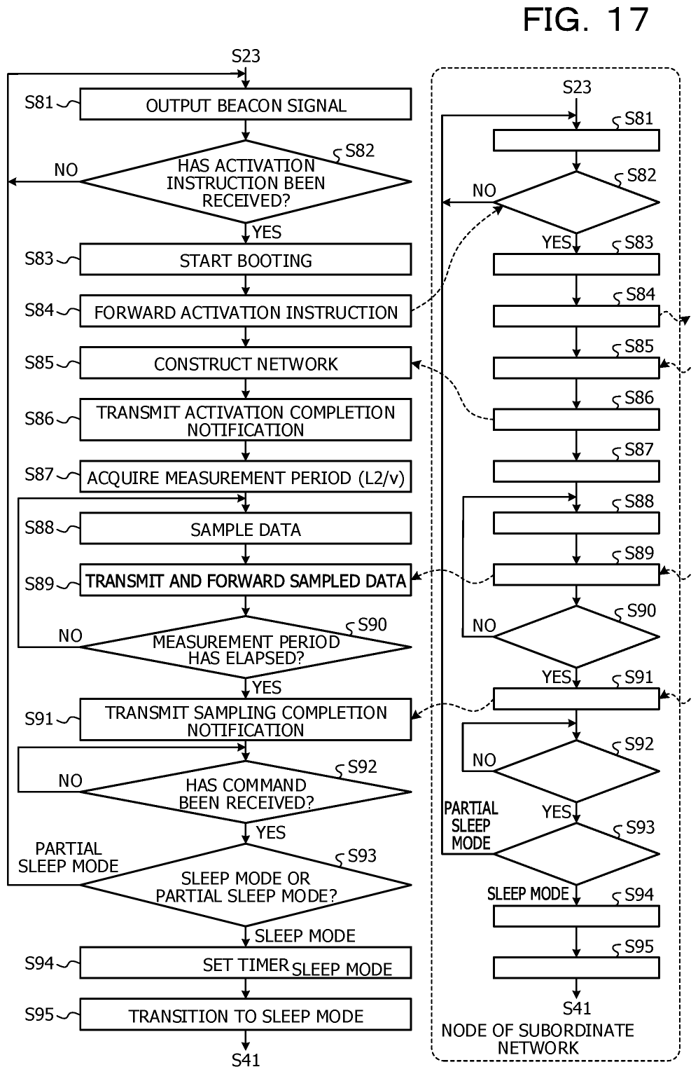

Upon completion of the process of Step S55, the main control unit 221 advances the flow to Step S81 (see FIG. 17).

FIG. 16 is a flowchart illustrating processes executed by the gateway 100. The processes illustrated in FIG. 16 are processes subsequent to Step S4 illustrated in FIG. 12, and start from the state where the sensor nodes 200A to 200E are set in the partial sleep mode.

The time acquisition unit 112 sends a request to the information server 50 and determines whether the time acquisition unit 112 has received the time tss at which the car 5A will enter the bridge 1 and the measurement period (L2/v) from the information server 50 (Step S61). The time acquisition unit 112 repeatedly executes the process of Step S61 until the time acquisition unit 112 receives the time tss and the measurement period (L2/v).

The time calculation unit 113 obtains a boot start time tbs by subtracting the boot period Tb from the time tss (Step S62).

The main control unit 111 determines whether the boot start time tbs obtained in Step S62 has passed (Step S63). The process of Step S63 is repeatedly executed until the boot start time tbs has passed.

If the main control unit 111 determines that the boot start time tbs has passed in Step S63 (S63: YES), the main control unit 111 transmits an activation instruction to the sensor nodes 200A to 200E (Step S64). The activation instruction is an instruction causing the sensor nodes 200A to 200E to immediately transition from the partial sleep mode to the activation mode.

The main control unit 111 transmits a measurement period (L2/v) to the sensor nodes 200A to 200E (Step S65).

The main control unit 111 receives measurement data from the sensor node 200A (Step S66).

The main control unit 111 determines whether the main control unit 111 has received a sampling completion notification from the sensor node 200A (Step S67). The sampling completion notification which the gateway 100 receives from the sensor node 200A is a notification indicating that the sampling by the sensor nodes 200A to 200E has been completed. If the main control unit 111 determines that the main control unit 111 has not received a sampling completion notification (S67: NO), the main control unit 111 returns the flow to Step S66.

The main control unit 111 determines whether the selected mode is the sleep mode or the partial sleep mode (Step S68).

If the main control unit 111 determines that the partial sleep mode has been selected in Step S68, the main control unit 111 transmits a command to stand by in the partial sleep mode to all the sensor nodes 200A to 200E (Step S69). As a result, the sensor nodes 200A to 200E stand by in the partial sleep mode.

On the other hand, if the main control unit 111 determines that the sleep mode has been selected in Step S68, the main control unit 111 transmits a command to transition to the sleep mode and the boot start time tbs[n] to the sensor nodes 200A to 200E (Step S70).

Upon completion of the process of Step S70, the main control unit 111 advances the flow to Step S31 (see FIG. 14).

FIG. 17 is a flowchart illustrating processes executed by the sensor nodes 200. The processes illustrated in FIG. 17 are processes subsequent to Step S23 illustrated in FIG. 13, and start from the state where the sensor nodes 200A to 200E are set in the partial sleep mode.

The main control unit 221 causes the beacon outputting unit 243 to output beacon signals (Step S81). The beacon outputting unit 243 outputs beacon signals from the antenna 250 every predetermined time (for example, 1 second).

The main control unit 221 determines whether the main control unit 221 has received an activation instruction from the gateway 100 (Step S82). The main control unit 221 repeatedly executes the processes of Steps S81 and S82 until the main control unit 221 receives the activation instruction.

If the main control unit 221 determines that the main control unit 221 has received the activation instruction (S82: YES), the main control unit 221 starts booting (Step S83).

The main control unit 221 forwards the activation instruction to the other sensor nodes 200B to 200E in order to construct the network with the other sensor nodes 200B to 200E (Step S84).

Upon receipt of the activation completion notifications indicating that the booting has been completed from all the other sensor nodes 200 (200B to 200E), the main control unit 221 constructs the network with the other sensor nodes 200B to 200E (Step S85). In the process of Step S85, the sensor nodes 200 within the communication range construct the network. In this way, the network having a mesh structure as illustrated in FIG. 8 is constructed.

The main control unit 221 transmits an activation completion notification indicating that the booting of the sensor nodes 200A to 200E has been completed to the gateway 100 (Step S86).

The main control unit 221 acquires a measurement period (L2/v) from the gateway 100 (Step S87).

The main control unit 221 causes the sensor 230 to sample data (Step S88).

The main control unit 221 transmits data sampled by the sensor 230 of the sensor node 200A to the gateway 100 and forwards (relays) data sampled by the sensors 230 of the sensor nodes 200B to 200E to the gateway 100 (Step S89).

The main control unit 221 determines whether the measurement period has elapsed (Step S90). If the main control unit 221 determines that the measurement period has not elapsed (S90: NO), the main control unit 221 returns the flow to Step S88. As a result, the processes of Steps S88 to S90 are repeatedly executed, so that data is sampled by the sensors 230 of the sensor nodes 200A to 200E.

If the main control unit 221 determines that the measurement period has elapsed in Step S90 (S90: YES), the main control unit 221 transmits a sampling completion notification indicating that sampling by the sensor nodes 200A to 200E has been completed to the gateway 100 (Step S91).

The main control unit 221 determines whether the main control unit 221 has received a command from the gateway 100 (Step S92). If the main control unit 221 determines that the main control unit 221 has not received a command from the gateway 100 (S92: NO), the main control unit 221 repeatedly executes the process of Step S92.

The main control unit 221 determines whether the received command is the sleep mode or the partial sleep mode (Step S93).

If the main control unit 221 determines that the received command is the partial sleep mode in Step S93, the main control unit 221 returns the flow to Step S81. In this case, the sensor nodes 200A to 200E stand by in the partial sleep mode.

On the other hand, if the main control unit 221 determines that the received command is the sleep mode in Step S93, the main control unit 221 sets the timer 212 so as to wake up at the boot start time tbs[n] (Step S94).

The main control unit 221 transitions to the sleep mode (Step S95). In this way, the sensor node 200A transitions to the sleep mode. The switching of the modes is conducted by the mode switching unit 222.

Upon completion of the process of Step S95, the main control unit 221 advances the flow to Step S41 (see FIG. 15).

As described above, when the sensor node 200 is standing by in the partial sleep mode, the sensor node 200 starts booting at the boot start time tbs which is earlier by the boot period Tb than the time tss at which an event will occur and completes the booting at the event occurrence time (time tss) to be capable of sampling data with the sensor 230. For this reason, it is possible to start sampling at the time when an event occurs (time tss).

When the sensor node 200 is standing by in the sleep mode, the sensor node 200 starts booting at the boot start time tbs[n] which is obtained by subtracting the boot period Tb from the departure time t3[n] at the bus stop and completes the booting at the event occurrence time (time tss) to be capable of sampling data with the sensor 230. For this reason, it is possible to start sampling at the event occurrence time.

Whether the sensor node 200 is standing by in the partial sleep mode or the sleep mode, it is possible to obtain data on vibration (acceleration) generated in the bridge 1 from when a car 5A or fixed-route bus 5B enters the bridge 1 to when the car 5A or fixed-route bus 5B completely passes through the bridge 1.

Hence, it is possible to provide the data collection system 10, the gateway 100, the sensor node 200, and the data collection method that are capable of efficiently collect data.

Since the data collection system 10 includes the sensor node 200 which stands by in the partial sleep mode and the sleep mode while no event is occurring, the data collection system 10 does not sample data when no event is occurring. In particular, for example, in a case where the bridge 1 is in a rural area with a small amount of traffic, far away from cities and the amount of traffic per hour is about several cars, the time during which no event occurs is very long. In such a case, if a sensor apparatus that stands by in an activation mode all the time were used instead of the sensor node 200, the sensor apparatus would acquire a huge amount of data, thus have to have a memory with a huge capacity, and have a huge amount of data to be communicated. Such a sensor apparatus is also very expensive.

In contrast, the sensor node 200 is activated only when an event occurs, and is activated at the boot start time tbs earlier by the boot period than the time at which the event occurs. This allows the memory 223 to be small and also allows the amount of data to be communicated to be small. It is also possible to achieve a data collection system 10 including such a sensor node 200 and a gateway 100 at a very low cost.

Hence, the data collection system 10 is installable relatively easily and is easily installable at more locations.

The above-description has been made on the embodiment in which the event is an event in which a vehicle (a car 5A or a fixed-route bus 5B) passes through the bridge 1, an incident caused by the event is vibration generated in the bridge 1, and the acceleration of the vibration generated in the bridge 1 is measured by the sensor 230 of the sensor node 200.

However, the data collection system 10 other than the above may be utilized in various applications. For example, it is possible to use a sensor that detects displacement instead of the sensor 230 and to detect displacement of a cliff alongside a road before a car 5A or a fixed-route bus 5B passes. If the risk of landslide is detected before a car 5A or a fixed-route bus 5B passes, it is possible to avoid an accident.

Although the above-description has been made on the embodiment in which the sensor node 200 includes the sensor 230, a configuration is possible in which the sensor 230 is separate from the sensor node 200. In this case, it is possible to employ a configuration in which the sensor 230 is coupled to a communication node including the PMU 210, the control apparatus 220, the communication unit 240, and the antenna 250.

Although the data collection system, the information processing apparatus, the communication node, and the data collection method according to the embodiment of the disclosure have been described so far, the disclosure is not limited to the specifically disclosed embodiment, and various modifications and variations are possible without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data collection system comprising:
an information processing apparatus; and
a communication node coupled to the information processing apparatus, wherein
the information processing apparatus is configured to
acquire a predetermined event occurrence time from a server,
calculate an activation start time that is earlier than the acquired event occurrence time by an activation period of the communication node, and
transmit the calculated activation start time to the communication node, and
the communication node is configured to
start activation at the activation start time received, and acquire predetermined data detected by a sensor upon completion of the activation, and
transmit the acquired predetermined data to the information processing apparatus.

2. The data collection system according to claim 1, wherein
the predetermined event occurrence time is obtained by the server based on a time contained in a schedule of a predetermined vehicle.

3. The data collection system according to claim 2, wherein
the predetermined event occurrence time is a passage time at which the predetermined vehicle passes through a detection position at which the sensor detects the predetermined data, the passage time being obtained by the server based on a time contained in the schedule of the predetermined vehicle, a position contained in the schedule of the predetermined vehicle, and the detection position.

4. The data collection system according to claim 1, wherein
the predetermined event occurrence time is a passage time at which a predetermined vehicle passes through a detection position at which the sensor detects the predetermined data, the passage time being obtained by the server.

5. The data collection system according to claim 3, wherein
the detection position is a position at which a predetermined structure is provided alongside a road, and
the sensor detects displacement of the predetermined structure as the predetermined data.

6. An information processing apparatus comprising:
a memory;
circuitry coupled to the memory, the circuitry configured to:
acquire a predetermined event occurrence time,
obtain an activation start time that is earlier than the acquired event occurrence time by an activation period of a communication node, and
transmit the obtained activation start time to the communication node.

7. A communication node comprising:
a memory;
circuitry coupled to the memory, the circuitry configured to:
receive an activation start time that is earlier than a predetermined event occurrence time by an activation period of the communication node,
start activation at the received activation start time,
acquire predetermined data detected by a sensor upon completion of the activation, and
transmit the acquired predetermined data to an information processing apparatus.

8. A data collection method in a data collection system, the data collection method comprising:
acquiring a predetermined event occurrence time by means of an information processing apparatus;
obtaining an activation start time that is earlier than the predetermined event occurrence time by an activation period of a communication node, by means of the information processing apparatus;
transmitting the activation start time to the communication node by means of the information processing apparatus;
receiving the activation start time by means of the communication node;
starting activation at the activation start time by means of the communication node;
acquiring predetermined data detected by a sensor upon completion of the activation by means of the communication node; and
transmitting the acquired predetermined data to the information processing apparatus by means of the communication node.

9. The data collection method according to claim 8, wherein
the predetermined event occurrence time is obtained by the server based on a time contained in a schedule of a predetermined vehicle.

10. The data collection method according to claim 9, wherein
the predetermined event occurrence time is a passage time at which the predetermined vehicle passes through a detection position at which the sensor detects the predetermined data, the passage time being obtained by the server based on a time contained in the schedule of the predetermined vehicle, a position contained in the schedule of the predetermined vehicle, and the detection position.

11. The data collection method according to claim 8, wherein
the predetermined event occurrence time is a passage time at which a predetermined vehicle passes through a detection position at which the sensor detects the predetermined data, the passage time being obtained by the server.

12. The data collection method according to claim 11, wherein
the detection position is a position at which a predetermined structure is provided alongside a road, and
the sensor detects displacement of the predetermined structure as the predetermined data.
